(19) United States
(12) Patent Application Publication
(10) Pub. No.: US 2012/0265601 A1
(43) Pub. Date: Oct. 18, 2012

(54) Advertising Campaigns in Retail Outlets and Restaurants

(76) Inventors: David Yang, Moscow (RU); Maxim Nalsky, Moscow (RU)

(21) Appl. No.: 13/397,707

(22) Filed: Feb. 16, 2012

Related U.S. Application Data
(60) Provisional application No. 61/445,015, filed on Feb. 21, 2011.

(51) Int. Cl. G06Q 30/02

(52) U.S. Cl. 705/14.38

(57) ABSTRACT

Disclosed is advertising campaigns to attract customers to a business or establishment. One or more advertising campaign parameters are provided to a location based service operating on one or more computer systems. An identification for each appropriate customer is provided by a location based service. A promotion code for a discount for a service or product offered by the business is provided to each appropriate customer. The promotion code is used at a point of sale device of the business when an appropriate customer presents the promotion code at the point of sale. Variations are described.

### CROSS-REFERENCE TO RELATED APPLICATIONS

For purposes of the USPTO extra-statutory requirements, the present application claims priority to U.S. Patent Provisional Application No. 61/445,015 that was filed on 21 Feb. 2011, and claims the benefit of its filing date.

The United States Patent Office (USPTO) has published a notice effectively stating that the USPTO's computer programs require that patent applicants reference both a serial number and indicate whether an application is a continuation or continuation-in-part. See Stephen G. Kunin, Benefit of Prior-Filed Application, USPTO Official Gazette 18 Mar. 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### BACKGROUND OF THE INVENTION

1. Field

The invention relates to systems and methods for organizing advertising campaigns in restaurants, fitness centers, beauty salons, retail outlets and any other establishments providing goods and services to customers. This includes small, individual businesses as well as franchises and chains. The main technical means used in the present invention include a Web site, mobile communication devices with Internet access (such as but not limited to cell phones or tablet computers), and geolocation tools (such as but not limited to GPS navigators, mobile phones with embedded positioning capabilities, pages, in-car phone systems, and others).

2. Description of the Related Art

Restaurants, retail outlets and other businesses, such as beauty salons, gas stations, cafes, bars and service centers usually do not have enough funds to invest in large-scale advertising campaigns. Their customer base is not wide enough, and delivering information about special events and offers to each client personally is too expensive. Even if the majority of customers are subscribed to such news updates, the customer base cannot be automatically expanded. Such a campaign does not allow attracting new clients based on their personal information—age, sex, biometric and anthropological data, consumption patterns and history, preferences, location (workplace and residential), travel habits, professional and other interests, etc. Chain businesses—such as restaurant, gas station or retail chains—may also prefer cost-efficient, easy to organize campaigns that are able to reach a wide audience of regular or potential customers.

Some businesses place their advertising banners and flyers in social networks. However, even in this case it is not possible to use declared or actual information about the customer's preferences or businesses that he or she frequents.

### BRIEF DESCRIPTION OF THE DRAWINGS

FIG. 1 is a flowchart of steps performed in accordance with one embodiment of the invention.

FIG. 2 is an approximate diagram of how the technical means may be used to implement the present invention, in accordance with one embodiment of the invention.

### DETAILED DESCRIPTION OF THE INVENTION

The invention (“Promotion Service”) enables restaurants, retail outlets and other businesses avoid the trouble of organizing a traditional advertising campaign while determining and attracting an appropriate contingent of customers. This type of advertising takes account of every customer it brings into the restaurant/retail outlet. This allows the advertising campaign to calculate its efficiency and the payment the service may receive from the restaurant/retail outlet for conducting the advertising campaign.

In one embodiment of the present invention, the Promotion Service may be implemented as a Web service that allows small businesses, as well as large retail or restaurant chains and the like, to create advertising campaigns and make each potential customer aware of it. In order to do so, the advertiser may access a website affiliated with the service and enter (and store) one or more campaign parameters, for example, the business name(s), their location(s), the dates and times of the advertising campaign, the bonuses offered to the customer, the discounts for specific types of goods, drinks or dishes, etc. The Promotion Service can be tied to a certain loyalty system or can be an independent service that other loyalty systems address or use. The loyalty system, in particular, allows its customers to have a single electronic wallet for making payments as well as for accumulating and spending bonus points, rewards and discounts in different facilities of a single chain or for all businesses participating in the Promotion Service.

After the parameters of the advertising campaign are entered, the Promotion Service calculates parameters associated with the customer base for a specific campaign. For example, these parameters may be the suggested sex, age, occupation, consumption patterns, geographic location of residence or workplace, etc. Additionally, in order to attract new clients, the advertising campaign may be announced in the social networks of the advertiser and the Promotion Service, as well as in any other public social networks that do not require mandatory registration. This means that in order to receive a flyer, a new client who is not registered in the network can, for example, send a text message to the specified number. In an alternative implementation, a client of a business can register with a Web service and request to receive the flyer.

The service also addresses one or more Location-based Services (LBS). In one embodiment this can be a social network with the ability of tracking the current location of its users' mobile equipment (ME). The LBS does not require use of GPS or A-GPS technology to determine customer location. For example, location can be determined through the base stations of GSM and UMTS cellular networks.

In another embodiment, location of a customer or participant can be determined by any LBS that does not necessarily enable determining the location of the mobile device itself, but ties its location to reference points charted on the LBS system's electronic map by the mobile network operator, service provider or the LBS participants. The methods used to find the subscriber in the network can be different, such as (but not limited to) Cell of Origin, TOA (Time of Arrival), OTD (Observed Time Difference), A-GPS (Assisted Global Positioning System), etc.

The Promotion Service, the loyalty system, as well as the LBS as a participant of the advertising campaign, can choose a mode of participation—for example, one-time mail-out of flyers; presenting active customers with award flyers/coupons; the possibility of increasing the customer base depending on the advertising campaign's interim results. Otherwise, the mode of participation of the Promotion Service and the LBS can be determined by the advertiser in the process of designing the campaign or can be changed by the advertiser when the campaign is already being implemented. The selected mode of participation may determine the settlement of accounts with restaurants/retail outlets. The advertiser, loyalty system or the Promotion Service can, at any moment, limit the number of distributed coupons, extend the term of the advertising campaign or stop the campaign altogether.

After the parameters of the campaign are transferred to one or more LBS, the LBS finds appropriate customers—i.e. it filters the whole range of its customers based on the parameters of the advertising campaign and sends them PUSH-messages or SMS text messages (and the like) with a portion or an entirety of text of the flyer (or invitation). In one embodiment, the text of the flyer may already contain the promotion code, which the customer can demonstrate when ordering or making a payment in a restaurant/retail outlet. In another embodiment, a customer checks in upon arrival in a restaurant/retail outlet and then receives a message on his or her mobile phone; the message contains the promotion code that entitles the customer to a discount. In yet another embodiment, the LBS, through one of the described technical means, “identifies” a customer who has just entered the vicinity of the site of the advertising campaign and sends a message with the promotion code to his or her mobile device.

In all of the aforementioned embodiments the promotion code is entered (accounted) when the customer pays for goods or services. The promotion code is the basis for receiving a discount, bonus or some other reward. When the promotion code is entered at the time of transaction, the appropriate LBS receives a notice that its code has been activated. Thus, the Promotion Service and each LBS “know” or are aware of the exact number of customers that they have “brought” or enticed to a certain restaurant/retail outlet in a set amount of time or during a particular campaign. This number of customers can be used as the starting point for calculating an amount of remuneration owed to the LBS or the Promotion Service by the restaurant/retail outlet.

The promotion code identifies each customer attracted to the restaurant/retail outlet by the advertising campaign. Thus, all the information about the customers available in the accessed social networks or LBS can be used to receive statistical data about the efficiency of the campaign, the contingent of customers that responded to the given campaign, the practicality of campaign sites or the correctness of a selected special offer.

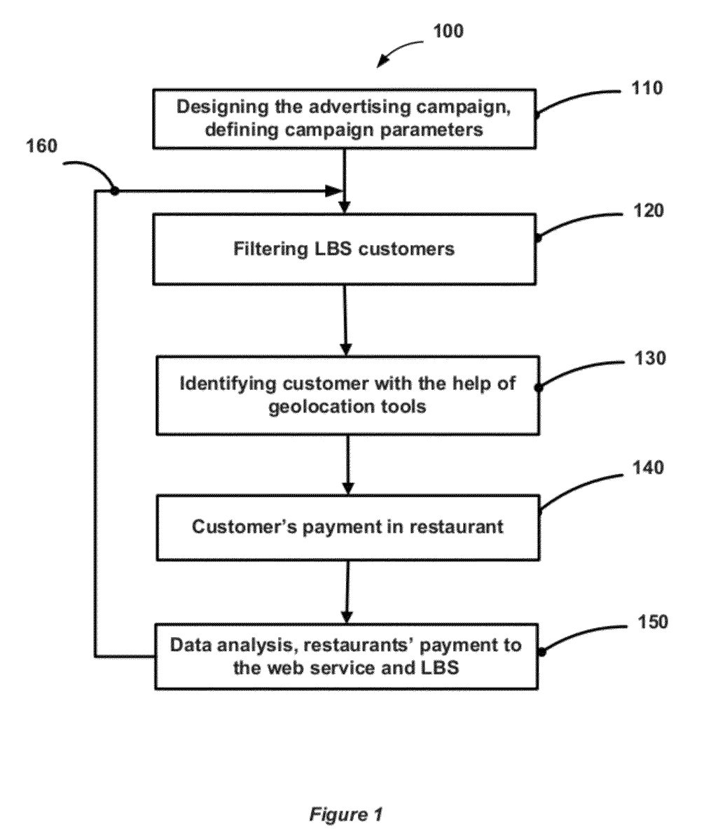

FIG. 1 shows a flowchart of steps performed by the web service and the LBS, in accordance with an embodiment of the present disclosure. At step 110, the advertiser uses the web service to design a specific advertising campaign and sets its parameters. The campaign data is transferred to the LBS. Then, at step 120, the LBS filters the mass of its customers, selecting those who might or would likely be interested in the specific advertising campaign. The determined customers then receive the advertising flyer or related information in a SMS text message, multimedia message or some other mobile alert, for example, a PUSH notification, etc. The flyer may already contain a promotion code—or the code will be sent to the customer at the moment of identification.

The next step 130 is the actual, physical or virtual arrival of the invited customer to the restaurant/retail outlet and the identification of the customer with the help of one or more geolocation tools. Any means of authorization may be used for identification: the customer may use his mobile device to identify himself on a website or in some special application; other possible means are RFID tags, Bluetooth, biometry, etc. In one embodiment, the identification may be accompanied by a check-in procedure with the generation of a promotion code or by delivery of an additional flyer containing a promotion code or an additional special offer. In another embodiment, the customer already has the promotion code, identifies himself through a mobile device and enters the code at a loyalty system website, loyalty system's website, or sends a text message. At that moment, the loyalty system authorizes the discount or bonus in the cash register system and the customer is notified that the discount or bonus has been authorized. In yet another embodiment, if the customer has enough funds or credits in his loyalty system e-wallet or customer account, he may receive an additional discount based on those funds (to be withdrawn from the e-wallet or customer account).

During step 140, when the customer pays the restaurant/retail outlet, the promotion code generated as part of the advertising campaign is factored in and the bonus or discount is applied. The customer receives the discount, bonus and/or additional bonus points to his account, while the restaurant/retail outlet records information about a new customer acquired through the advertising campaign created with the help of the Promotion Service of the present invention. Also recorded is the information about this new customer's transaction (i.e. dishes ordered/items purchased, number of guests at table, etc.). The information can be registered and accounted automatically when the promotion code is entered and activated, which eliminates the possibility of staff negligence or misuse. Information can be transferred to the LBS, Promotion Service and/or loyalty system.

Step 150 includes the analysis of data received from restaurants/retail outlets and LBS. This may include analysis of data about customers acquired through the advertising campaign and the total amount of purchases. The analysis may also be very specific, including the choice of a certain product, dish or drink offered as part of the advertising campaign (or not offered as part of the advertising campaign) or the number of visitors of a specific restaurant/retail outlet. In one embodiment, if the LBS offers this kind of information, it is possible to make conclusions about the contingent of customers the advertising campaign was able to attract to the certain restaurant/retail outlet, for example, about customer age, sex, occupation, etc.

The LBS, Promotion Service and/or loyalty system may receive either information about each particular customer or daily/weekly summary reports. Such reports may be generated by the LBS, Promotion Service or loyalty system. The reports may contain information about each particular customer. The reports (or the information therein) may serve as the foundation for revising or adjusting one or more parameters of the advertising campaign. Link 160 demonstrates the influence such information can have on the implementation of the campaign. Step 150 may also include redistribution of revenue that restaurants/retail outlets receive as the result of the advertising campaign; a portion of this revenue may be transferred to the Promotion Service, the LBS or separate business entity.

The described method of organizing advertising campaigns may be aimed at keeping regular customers. A different method of organizing campaigns may be targeted at increasing the customer base of restaurants/retail outlets. During the check-out process, a restaurant patron receives a coupon from a loyalty system with a promotion code, promising additional bonuses for bringing friends to the restaurant. The customer logs in at (authenticates with) the loyalty system's website, enters the promotion code and receives an invitation to publish his own recommendation on this website or on any social network website. This can be a recommendation to visit a specific restaurant, to try a certain dish, or it can be simply a personal review of the venue, etc.

The system offers the customer a personal “code word” to be published on the customer's own website or in another social network. The loyalty system describes the discount or bonus that other visitors will receive for using the code word. The customer may use the standard text suggested by the loyalty system or write his or her own text. The only requirement is that the recommendation text must contain the code word; if after reading the recommendation any person decides to take advantage of the offer, he or she may enter this code word on a mobile device during the authorization process, when creating an order or checking out, or inform a waiter or salesperson of the code word in order receive a discount. The loyalty system transfers the information about the discount or bonus directly to the restaurant/retail outlet's cash register system.

The code word (for example, a unique word for the specific loyalty system) may also be used for adding a bonus sum to the customer's account, when the word is used for the first time or when the customer creates an account/electronic wallet for a given venue, perhaps even before coming to the restaurant, without tying it to the promotion code.

However, the customer may be restricted from spending e-wallet funds until the sum has reached a certain amount or minimum. There may also be restrictions on how often the code word can be applied, for example, a limited time term, after which such offers expire, as well as other restrictions. The expiration date for each code word may be set by the loyalty system.

The code word can be used by any friend of the customer, as well as by any person who has read the customer's recommendation. Moreover, the person who knows the code word may distribute it in any possible way. Specific loyalty systems may implement different models for using the code word. For example, the code word may ensure the subtraction of the cost of a certain dish (or dishes) not only when used for the first time, but every time (the so-called electronic flyer). In one embodiment, a certain sum (or a percentage of the cost of the whole order) may be subtracted from the bill with the purchase of the advertised dish or any dish from a special category (or categories). In another embodiment, there might be a specific date range after which the offer is no longer valid; the start date for the range would be the first use of the code word. In still another embodiment, there may be a minimum order sum required to use the code word.

In some embodiments, the code word (electronic flyer) may be registered in the loyalty system in advance, before coming to the restaurant. For example, the customer saw a banner or a notice in a social network promising a free coffee with a set minimal order during a specific time of day, or on a specific day of the week, or during a specified date range. In order to take advantage of this offer, the customer has to enter/present the code word. To make sure the customer does not forget this word before coming to the restaurant, there may be an opportunity to register this flyer at the loyalty system's website in advance. In this case, the loyalty system may have a special list of unused electronic flyers for each customer. Then, when the customer comes to the restaurant and enters the promo code (or logs in, or the system itself identifies the customer at the given venue with the help of geolocation tools), the system may automatically remind the customer of an available unused electronic flyer and, with the customer's permission, apply the necessary code word. If the flyer is about to expire, the loyalty system may remind the customer by sending a text message (SMS), for example, to use the flyer before a certain date. If the flyer can be used only on specific days of the week, for example, then the loyalty system may regularly remind the customer of the available unused electronic flyer.

In another embodiment, every time a personal code word is activated, the customer who had published it receives a bonus from the loyalty system. The customer may also be notified by the loyalty system about the number of customers he had attracted and/or about his position in the rating of “promoters”. The most active customer promoters may be rewarded with additional bonuses. Thus, every customer can become a promoter—and will automatically start encouraging his friends to dine in a specific restaurant. The given system of recommendations and code words can help create a graph of restaurant patrons who are acquainted with each other and to determine the graph vertex—the patron with the most “influence”.

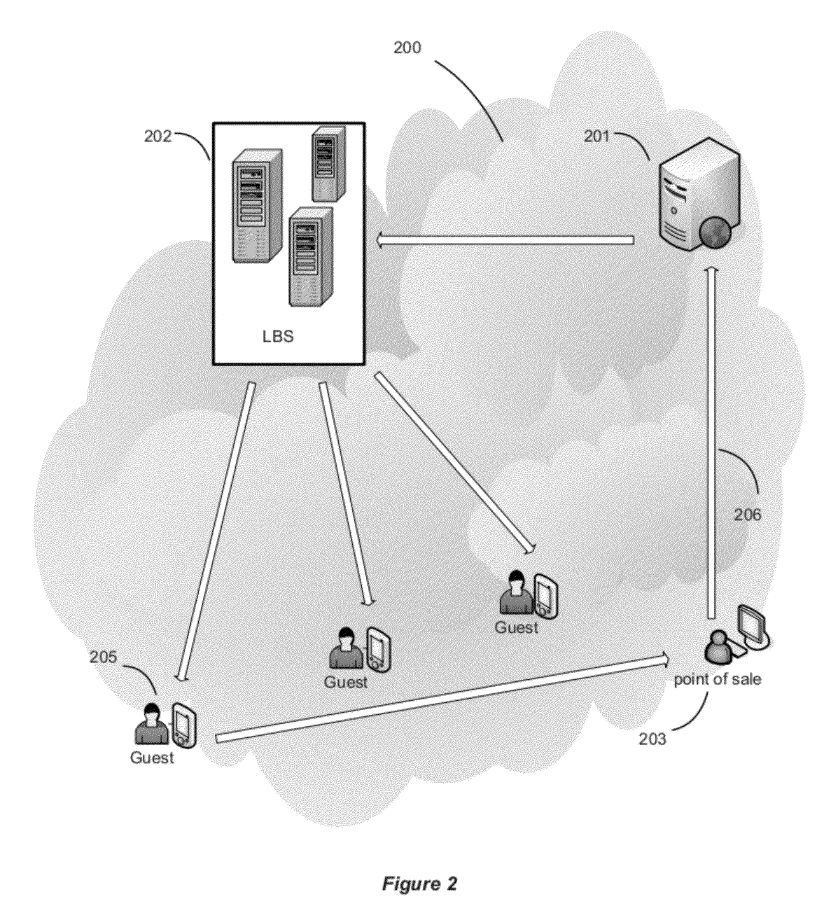

FIG. 2 is an approximate diagram of how the technical means may be used to implement a system in accordance with one embodiment of the invention. The web service-providing computer system may be implemented in a Wide Area Network (WAN) 200 that covers a broad area such as a city (the Internet, for example) and one or more Cellular Networks. The system itself (a web service) is an Internet resource (a website), possibly based on a loyalty system, hosted on one or more web servers 201. The web server 201 is connected by WAN (Internet) with one or more Location Based Services (LBS) 202 having databases of customers. The databases contain all the information about the customers: their mobile phone numbers, as well as personal data such as age, sex, occupation, etc. These LBS may connect with customers' mobile communication devices (for example, cell phones) by text messages (SMS), mobile Internet devices (MID's), or with any other devices connected or connectable to the Internet. A customer's payment to a restaurant/retail outlet is carried out through point-of-sale terminals 203 or other means. The point-of-sale terminals 203 may also be connected to a server that runs a restaurant/retail outlet management system, storing and managing information about orders, their origins, availability of tables, active promotion codes, etc. The point-of-sale terminals 203 connected with the restaurant/retail outlet management system are the point where the promotion code is entered and/or accounted.

Finally, the link 206 shows that information may be transferred to the web server 201; this can be information about promotion code activation, personal information about the customer, the bill amount and the bonus points granted, or any other information related to the promotion or about the dish rankings assigned by customers, about customer preferences, etc.

We claim:

1. A computer-implemented method for operating an advertising campaign to attract new customers for a business, the method comprising:
providing one or more advertising campaign parameters to a location based service operating on one or more computer systems;
receiving identification for each of a plurality of appropriate customers from the location based service;
sending a promotion code for a discount for a service or product offered by the business to each of the plurality of appropriate customers; and
receiving an indication of use of the promotion code at a point of sale device of the business when an appropriate customer presents the promotion code at the point of sale.

2. The computer-implemented method of claim 1 wherein the sending the promotion code for a discount for a service or product offered by the business to each of the plurality of appropriate customers is by sharing the promotion code in a social network.

3. The computer-implemented method of claim 1 wherein the sending the promotion code for a discount for a service or product offered by the business to each of the plurality of appropriate customers is performed when each of the plurality of appropriate customers enters a defined vicinity defined for the advertising campaign.

4. The computer-implemented method of claim 1 wherein the method further comprises:
modifying one or more of the advertising campaign parameters in response to receiving an item of information about a particular appropriate customer that presents the promotion code at the point of sale.

5. A computer readable storage medium encoded with instructions for performing a computer-implemented method for operating an advertising campaign to attract new customers for a business, the computer-implemented method comprising:
providing one or more advertising campaign parameters to a location based service operating on one or more computer systems;
receiving identification for each of a plurality of appropriate customers from the location based service;
sending a promotion code for a discount for a service or product offered by the business to each of the plurality of appropriate customers; and
receiving an indication of use of the promotion code at a point of sale device of the business when an appropriate customer presents the promotion code at the point of sale.

6. The computer readable storage medium of claim 5 wherein the instructions for sending the promotion code for a discount for a service or product offered by the business to each of the plurality of appropriate customers further comprises instructions for sharing the promotion code in a social network.

7. The computer readable storage medium of claim 5 wherein the instructions for sending the promotion code for a discount for a service or product offered by the business to each of the plurality of appropriate customers are performed when each of the plurality of appropriate customers enters a defined vicinity defined for the advertising campaign.

8. The computer readable storage medium of claim 5 wherein the computer-implemented method further comprises:
modifying one or more of the advertising campaign parameters in response to receiving an item of information about a particular appropriate customer that presents the promotion code at the point of sale.

9. A system for operating an advertising campaign to attract new customers for a business, the system comprising:
a processor;
a memory configured with instructions to perform a method comprising:
providing one or more advertising campaign parameters to a location based service;
receiving by the system an identification for each of a plurality of appropriate customers from the location based service, wherein the plurality of appropriate customers is found based at least in part on said one or more advertising campaign parameters;
sending a promotion code for a discount for a service or product offered by the business to each of the plurality of appropriate customers; and
receiving by a component of the system an indication of use of the promotion code when an appropriate customer presents the promotion code at the point of sale.

10. The system of claim 9 wherein the sending of the promotion code for a discount for a service or product offered by the business to each of the plurality of appropriate customers is by communicating the promotion code through a social network.

11. The system of claim 9 wherein the sending the promotion code for a discount for a service or product is a code word individualized to each of said appropriate customers.

12. The system of claim 9 wherein the sending of a promotion code includes sending to a mobile device associated with each respective appropriate customer a mobile alert.

13. The system of claim 12 wherein the mobile alert is customized at least in part based on an identity of the respective customer.

14. The system of claim 9 wherein the memory is further configured with instructions to process information about each particular customer, and wherein one or more advertising campaign parameters are adjusted based upon said information.

15. The system of claim 14 wherein the memory is further configured with instructions for redistributing revenue as a result of the advertising campaign.
